(19) United States
(12) Patent Application Publication
(10) Pub. No.: US 2004/0153738 A1
(43) Pub. Date: Aug. 5, 2004

(54) Redundancy management method for BIOS, data processing apparatus and storage system for using same

(75) Inventors: Atsuhiro Otaka, Kawasaki (JP); Isamu Miyashita, Kahoku (JP); Noriyoshi Tanaka, Kahoku (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 10/735,899

(22) Filed: Dec. 16, 2003

(30) Foreign Application Priority Data
Dec. 17, 2002 (JP) 2002-365618

(51) Int. Cl. H04L 1/22

(52) U.S. Cl. 714/6

(57) ABSTRACT

Redundancy management for BIOS sets the environment where the OS can use hardware for preventing the system startup from being disabled even if the BIOS is updated according to the CPU stepping change. The BIOS is redundant-managed by a pair of memories (32, 33), so that the memory in operation is switched to the memory in standby when the BIOS cannot be booted, and system startup is prevented from being disabled. When the BIOS is updated according to the CPU stepping change, data is written not to the two BIOS memories simultaneously but only to the BIOS memory in standby, and the BIOS currently in operation is not updated.

### CROSS-REFERENCE TO RELATED APPLICATIONS

This application is based upon and claims the benefit of priority from the prior Japanese Patent Application No. 2002-365618, filed on Dec. 17, 2002, the entire contents of which are incorporated herein by reference.

### BACKGROUND OF THE INVENTION

1. Field of the Invention

The present invention relates to a redundancy management method for BIOS (Basic Input/Output System), data processing apparatus and storage system for managing the redundancy of BIOS, and more particularly to a redundancy management method, data processing apparatus and storage system for BIOS where two BIOS memories are mounted.

2. Description of the Related Art

In a storage device using such a storage medium as a magnetic disk, magneto-optical disk and optical disk, the storage medium is actually accessed by the request of the data processing apparatus. To handle large capacity data, the data processing apparatus uses a storage apparatus which is comprised of a plurality of storage device and a control device.

In this storage apparatus, a redundant configuration is used to improve the reliability of the stored data and the reliability of the device. The storage control apparatus is comprised of a data processing apparatus including a CPU. The CPU provides users with various services, such as the allocation and protection of resources, the execution of programs, input/output operations and file operations by the OS (Operating System), which is a control program of the CPU.

The basic part of the OS for implementing these services is called a “kernel”. Recently in an OS, particularly an OS for a personal computer, the section for controlling hardware and the other section are created as different module groups so that a common OS can be operated even if different hardware is used. This hardware control section is called the BIOS (Basic Input/Output System), and the other section is called the kernel.

The BIOS checks the hardware of the computer system and sets the environment where the kernel can use the hardware. The BIOS has been bound with firmware and stored together with firmware in memory, which does not allow the operation of different versions (e.g. Japanese Patent Application Laid-Open No. 11-306007).

On the other hand, it is necessary to update BIOS versions frequently because of CPU stepping changes, that is, assigning the same version number to a CPU and a CPU modified due to bugs, so BIOS should be bound with the CPU and not with firmware. In other words, when a CPU stepping change occurs, the BIOS should be newer than the BIOS corresponding to the mounted CPU.

In prior art, if a memory storing BIOS is damaged by a power failure, for example, during writing for updating the BIOS, system operation is disabled. This means that even if BIOS is loaded to the main memory from the memory storing the BIOS, the BIOS of the memory is currently operating, so if a power failure occurs during writing BIOS, the BIOS before this writing is lost, and system operation is disabled.

Even if writing succeeded, the power recovery processing is performed with a BIOS different from the previous BIOS, so BIOS must be changed considering this case, where restrictions limit the update range of the BIOS.

### SUMMARY OF THE INVENTION

With the foregoing in view, it is an object of the present invention to provide a redundancy management method, data processing apparatus and storage system for BIOS for preventing system startup from being disabled, even if BIOS is rewritten during system operation.

It is another object of the present invention to provide a redundancy management method, data processing apparatus and storage system for BIOS for preventing system startup from being disabled, even if the rewriting of BIOS fails.

It is still another object of the present invention to provide a redundancy management method, data processor and storage system for BIOS for enabling power recovery processing of the system, even if a power failure occurs during rewriting BIOS.

To achieve these objects, the redundancy management method of the present invention includes steps of: using one of a pair of memories, which respectively store BIOS for setting the hardware in an environment in which the OS can use the hardware, for operation and the other for standby; switching to the BIOS in the memory in standby when the BIOS in the one memory cannot be booted; and executing an update of the BIOS by writing to the memory in standby.

The data processing apparatus of the present invention has a hardware including a CPU, a pair of memories which respectively stores BIOS for setting the hardware in an environment in which the OS can use the hardware, and a service processor for using one of the pair of memories for operation and the other for standby when the hardware is started up, and switching to the BIOS in memory in standby when the BIOS of the one memory cannot be booted. And the CPU executes an update of the BIOS by writing to the memory in standyby.

The storage system of the present invention has a storage control apparatus which has a hardware including a CPU, a pair of memories which respectively store BIOS for setting the hardware in the environment in which the OS can use the hardware, and a service processor for using one of the pair of memories for operation and the other for standby when the hardware is started up, and switching to the BIOS in memory in standby when the BIOS of the one memory cannot be booted, and a plurality of storage devices connected to the storage control apparatus. And the CPU of the storage control apparatus executes an update of the BIOS by writing to the memory in standby.

In the present invention, the redundancy management of BIOS is performed by a pair of memories, and the memory in operation is switched to the memory in standby when the BIOS cannot be booted so as to prevent system startup from being disabled. And when BIOS is updated according to the CPU stepping change, only the BIOS memory in standby is written, without writing the two BIOS memories at the same time, and the currently operating BIOS is not rewritten. So the system can be started using the currently operating BIOS if the update fails, which prevents system startup from being disabled.

Since only the memory in standby is updated, even if a power failure occurs during writing for the update, power recovery processing, using BIOS different from the one before the power failure, can be prevented.

It is preferable that the present invention further includes a step of permitting switching the memory in standby to the memory in operation when the update of the BIOS in the memory in standby succeeds. This guarantees switching to the updated BIOS.

It is preferable that the present invention further includes a step of switching the permitted memory in standby to a memory in operation, and the memory in operation to the memory in standby when the hardware is started up. This implements automatic switching to the updated BIOS.

It is preferable that the present invention further includes a step of writing the BIOS of the memory switched to operation, to the memory switched to standby for redundancy after the switching. This can also updates the BIOS of the other memory, which is not updated.

It is preferable that the present invention further includes a step of preventing switching the memory in standby to the memory in operation when the update of the BIOS in the memory in standby fails. By this, automatic switching to the BIOS, where update failed, can be prevented, and unnecessary switching can be prevented.

It is preferable that the present invention further includes a step of preventing switching the memory switched to standby, to the memory switched to operation when writing the BIOS in the memory switched to standby fails. This can prevent automatic switching to the BIOS for which redundancy processing failed, and unnecessary switching can be prevented.

It is preferable that the present invention further includes a step of executing an update of the BIOS in the memory in standby of another hardware connected with the hardware according to the update of the BIOS in the memory in standby of the hardware. By this, the update of BIOS of the pair of hardware can be executed simultaneously.

It is preferable that the present invention further includes a step of executing synchronization processing of BIOS with another hardware connected with the above mentioned hardware. By this, the version number of BIOS can be matched between hardware.

### BRIEF DESCRIPTION OF THE DRAWINGS

FIG. 1 is a block diagram depicting the storage system according to an embodiment of the present invention;

FIG. 2 is a block diagram depicting the storage program in FIG. 1;

FIG. 3 is a diagram depicting the redundancy management information of the RSP in FIG. 1;

FIG. 4 is a flow chart depicting the processing of BIOS in FIG. 1;

FIG. 5 is a diagram depicting the update of BIOS of an embodiment of the present invention;

FIG. 6 is a flow chart depicting the update processing of BIOS in FIG. 5;

FIG. 7 is a flow chart depicting the flash write processing of BIOS in FIG. 6;

FIG. 8 is a flow chart depicting the processing of the RSP when CM is started up in FIG. 1;

FIG. 9 is a flow chart depicting the redundancy processing of BIOS in FIG. 1;

FIG. 10 is a diagram depicting the operation of the update processing of BIOS in FIG. 6;

FIG. 11 is a diagram depicting the operation of the flash write processing of BIOS in FIG. 7;

FIG. 12 is a diagram depicting the operation of the redundancy processing of BIOS in FIG. 9;

FIG. 13 is a flow chart depicting the BIOS synchronization processing between the CMs according to another embodiment of the present invention; and

FIG. 14 is a diagram depicting the operation of the BIOS synchronization processing between CMs in FIG. 13.

### DESCRIPTION OF THE PREFERRED EMBODIMENTS

Embodiments of the present invention will now be described in the sequence of storage system, redundancy management processing for BIOS, BIOS synchronization processing between CMs and other embodiments.

[Storage System]

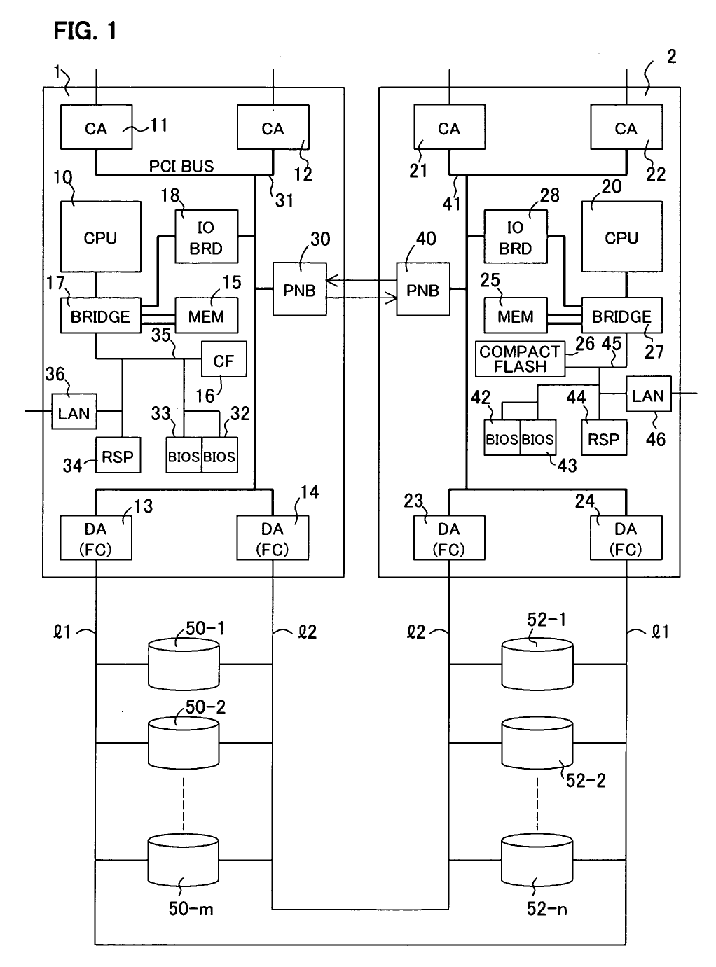

FIG. 1 is a block diagram depicting a storage system of an embodiment of the present invention, and shows a RAID (Redundant Arrays of Inexpensive Disk) system using a magnetic disk. As FIG. 1 shows, the storage system has a pair of magnetic disk controllers (hereafter called controllers) 1 and 2, and a plural of magnetic disk devices 50-1-50-m, 52-1-52-n which are connected to this pair of controllers 1 and 2 via the lines 11 and 12.

The controllers 1 and 2 are connected to the host and server directly or via network equipment, and can read or write large volumes of data of the host and server from/to the RAID disk drive (magnetic disk device) at random. The pair of controllers 1 and 2 have identical configurations, which has the function modules of CAs (Channel Adapters) 11, 12, 21, 22, CMs (Centralized Modules) 10, 15-19, 20, 25-29, and DAs (Device Adapters) 13, 14, 23, 24.

The CAs (Channel Adapters) 11, 12, 21, 22 are circuits for controlling the host interface to connect the host, and has a fiber channel circuit (FC) and a DMA (Direct Memory Access) circuit, for example. The DAs (Device Adapters) 13, 14, 23, 24 are circuits for exchanging commands and data with the disk device in order to control the disk devices 50-1-50-m/52-1-52-m, and has a fiber channel circuit (FC) and DMA circuit, for example.

CM (Centralized Module) has the CPU 10/20, bridge circuit 17/27, memory (RAM) 15/25, compact flash memory 16/26, IO bridge circuit 18/28, and a pair of BIOS flash memories 32 and 33/42 and 43. The CM further has RSP (Remote Service Processor) 34/44, and LAN port for external connection 36/46. The memory 15/25 is backed up by a battery and is used as a main memory.

The CPU 10/20 is connected to the memory 15/25, the compact flash memory 16/26, and the IO bridge circuit 18/28 via the bridge circuit 17/27. This memory 15/25 is used for the work area of the CPU 10/20, and the compact flash memory 16/26 stores the programs which the CPU 10/20 executes. For these programs, the kernel, file access programs (read/write programs) and the RAID management programs, for example, are stored.

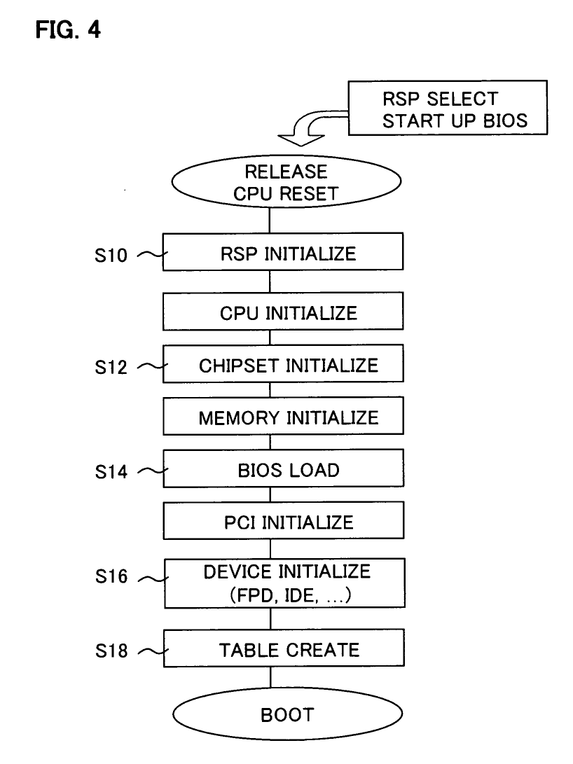

BIOS flash memories 32, 33/42, 43 are disposed as a pair for a redundant configuration, one is used for operation and the other for standby, and stores BIOS (later mentioned in FIG. 4). The CPU 10/20 executes programs and executes read/write processing and RAID management processing, for example.

The PCI bus 35/45 connects the CPU 10/20, the compact flash memory 15/25, a pair of BIOS flash memories 32, 33/42, 43, RSP 34/44, and LAN port 36/46 via the bridge circuit 17/27.

The RSP 34/44 is comprised of a processor which performs various remote services, and in the present embodiment, the RSP 33/44 performs redundancy management for the BIOS flash memories 32, 33/42, 43. The LAN port 36/46 is for connecting with an external LAN (Local Area Network).

The PCI (Peripheral Component Interface) bus 31/41 connects the CAs 11, 12/21, 22 and the DAs 13, 14/23, 24, and connects the CPU 10/20 and the memory 15/25 via the IO bridge circuit 18/28. The PCI-node link bridge (PNB) circuit 30/40 is also connected to the PCI bus 31/41.

The PCI-node link bridge circuit 30 of the controller 1 is connected with the PCI-node link bridge circuit 40 of the controller 2, and performs communication of the commands and data between the controllers 1 and 2.

The controller 1 is in-charge of the disk devices 50-1-50-m, for example, and the controller 2 is in-charge of the disk devices 52-1-52-n, for example. In FIG. 1, the disk devices 50-1-50-m and 52-1-52-n have the configuration of the RAID 5.

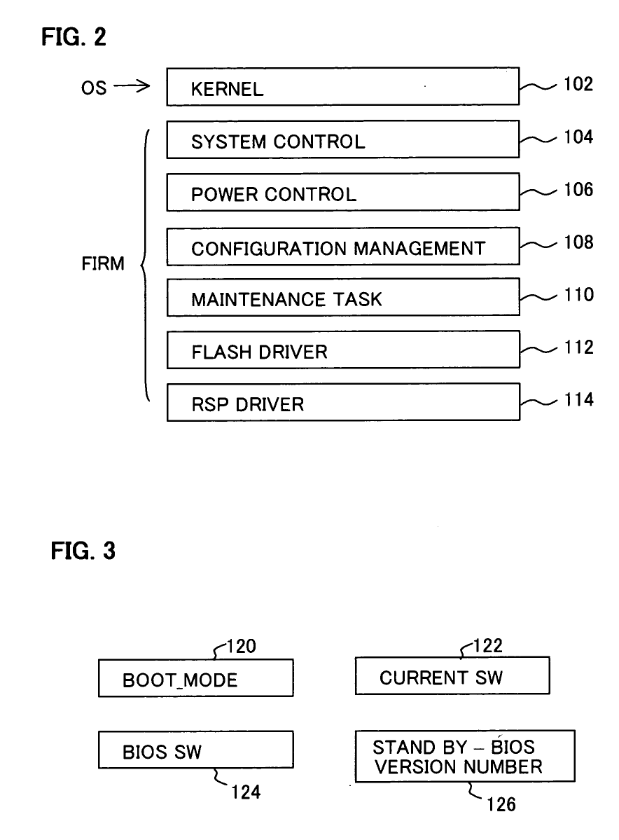

FIG. 2 is an example of the programs stored in the compact flash memory 16/26 of FIG. 1, and has the kernel 102, system control 104, power control 106, configuration management 108, maintenance tasks 110, flash driver 112 and RSP driver 114. The kernel 102 is the OS, and programs other than the kernel 102 are firmware.

FIG. 3 is a diagram depicting the BIOS redundancy management information stored in the NVRAM (Non-Volatile Random Access Memory) of the RSP 34/44 in FIG. 1. In FIG. 3, the boot mode 120 stores the boot mode (FAST/SLOW) of the BIOS. The current mode 122 stores the currently operating BIOS number #. The BIOS SW 124 stores the BIOS number # to be started at the next startup. The standby BIOS version number 126 stores the BIOS version number at the standby side.

FIG. 4 is a flow chart depicting the processing of the BIOS stored in the BIOS flash memory in FIG. 1. The BIOS checks the hardware in which the OS (kernel) uses, as mentioned above, and sets the hardware to an environment of which allows the OS (kernel) to use it. Therefore this processing is performed before loading the OS.

(S10) RSP 34/44 sets the BIOS to be started up, and when the reset of the CPU 10/20 is cleared, the CPU 10/20 reads the first block of the BIOS flash memory 32 (or 33)/42 (or 43), and initializes the RSP 34/44, that is, it makes setting so that the BIOS can use the functions of the RSP 34/44 at the beginning of the BIOS boot block. Then the CPU 10/20 is initialized. In other words, registers are set and a machine check is initialized so that CPU 10/20 can be used.

(S12) Each chip set (each bridge circuit 17, 18/27, 28, etc.) is initialized (disable, register setting). Also the memory 15/25 is initialized (enabled and diagnosed, and ECC is checked).

(S14) After initializing the memory 15/25 and the chip sets, BIOS is loaded from the BIOS flash memory to the memory 15/25. Then-the PCI devices (CAs 11, 12/21, 22, DAs 13, 14/23, 24, LAN port 36/46), connected to the PCI buses 31, 35/41, 45, are initialized.

(S16) If necessary other devices are initialized.

(S18) Then various tables are created and booting ends. By this, the kernel and other programs are loaded from the compact flash memory, 16 /26 to the memory 15/25, and the programs are started up.

In the storage system in FIG. 1, the cache memory disposed in the memory 15/25 stores a part of the data of the disk device in which the controller is in-charge of, and stores the write data from the host respectively in the controllers 1 and 2. The CPU 10/20 receives a read request from the host via the CAs 11, 12/21, 22, judges whether access to the physical disk is necessary by referring to the cache memory, and if necessary, the CPU 10/20 sends the disk access request to the DAs 13, 14/23, 24. The CPU 10/20 also receives a write request from the host, writes the write data to the cache memory, and requests a write back, which is internally scheduled, to the DAs 13, 14/23, 24.

[Redundancy Management Processing for BIOS]

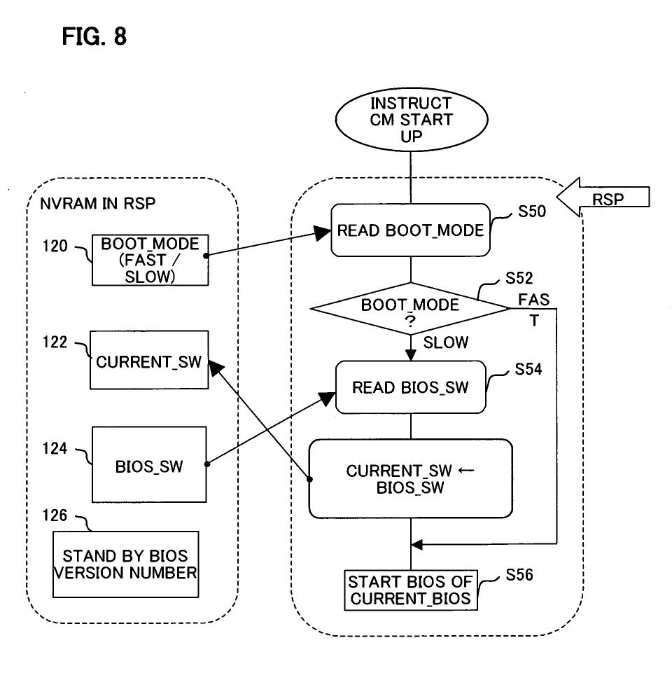

As mentioned above, each controller 1 and 2 physically has two BIOS flash memories (Flash ROM). A BIOS with the same version is stored in these two flash memories, and redundancy management (described later in FIG. 8) is performed so that even if one BIOS flash memory (Flash ROM) 32/42 cannot be booted, a BIOS with the same version number can be started up from the other BIOS flash memory 33/43.

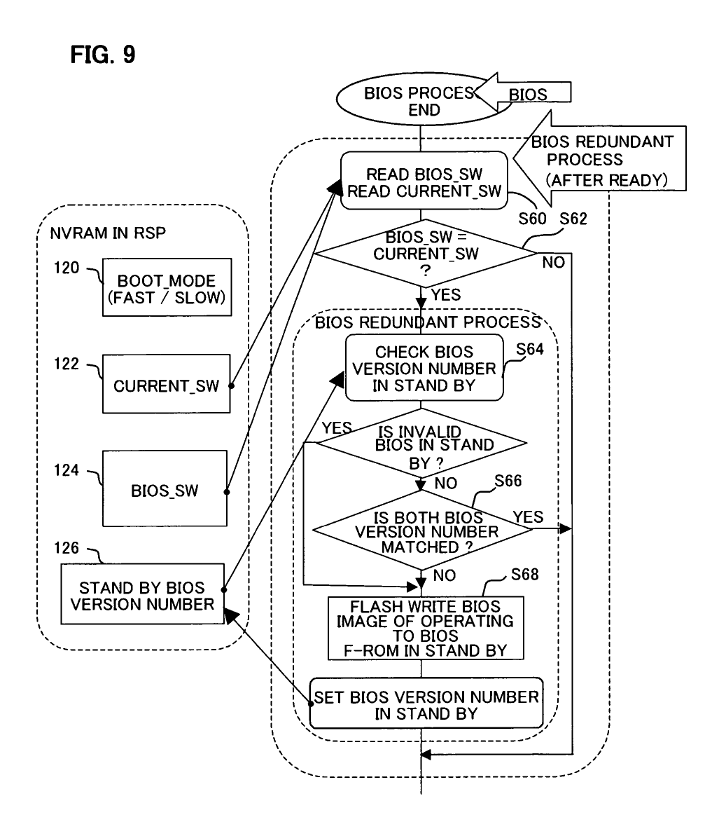

The redundancy of the BIOS is implemented by the BIOS redundancy processing firmware (described later in FIG. 9) after BIOS processing ends. The BIOS to be started up is switched by the processors of RSP 34/44.

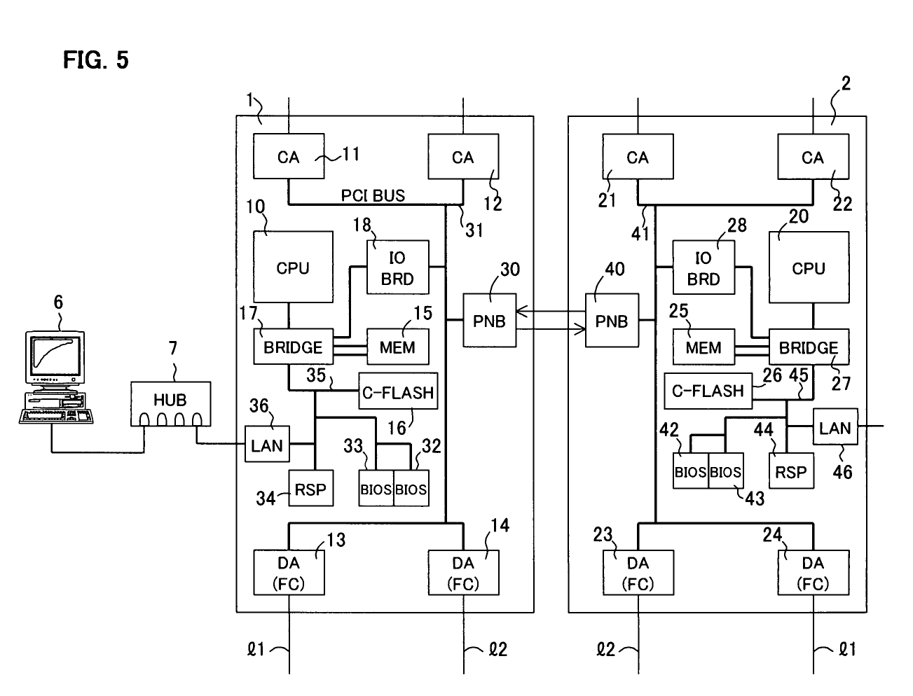

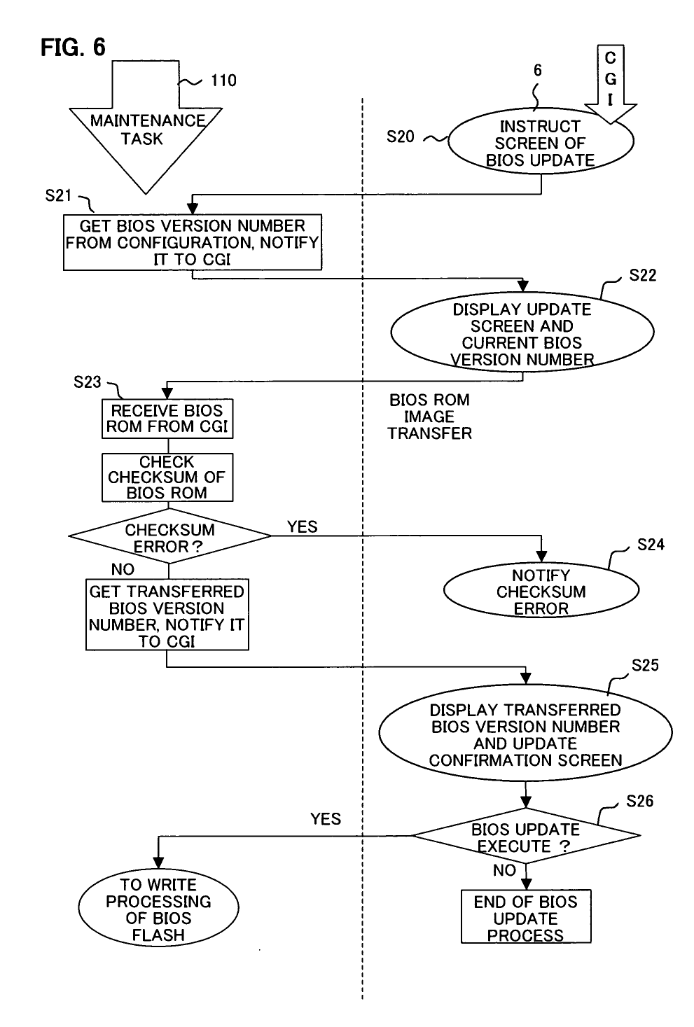

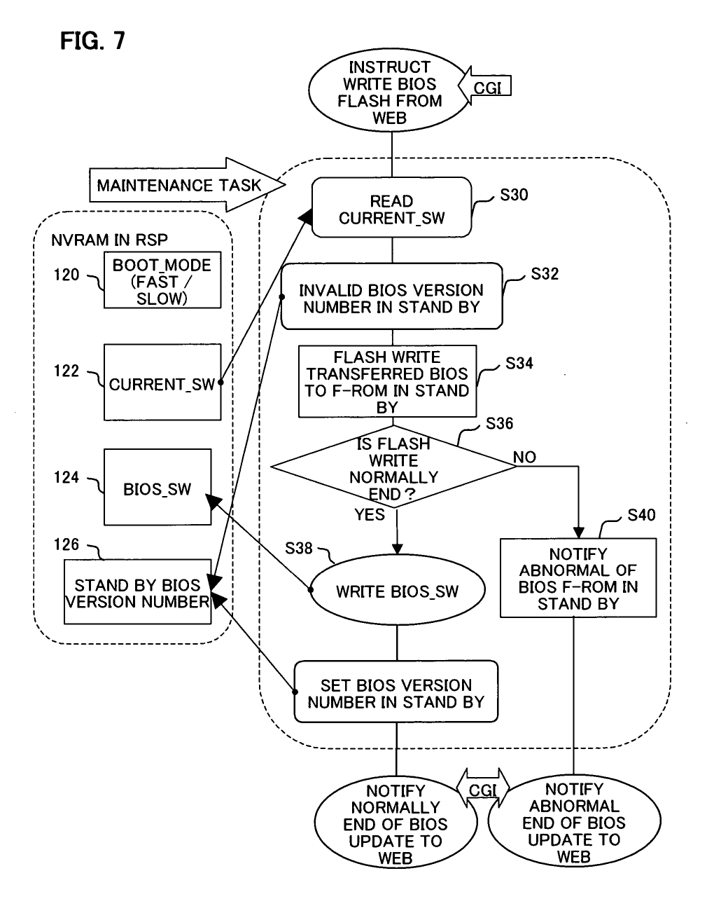

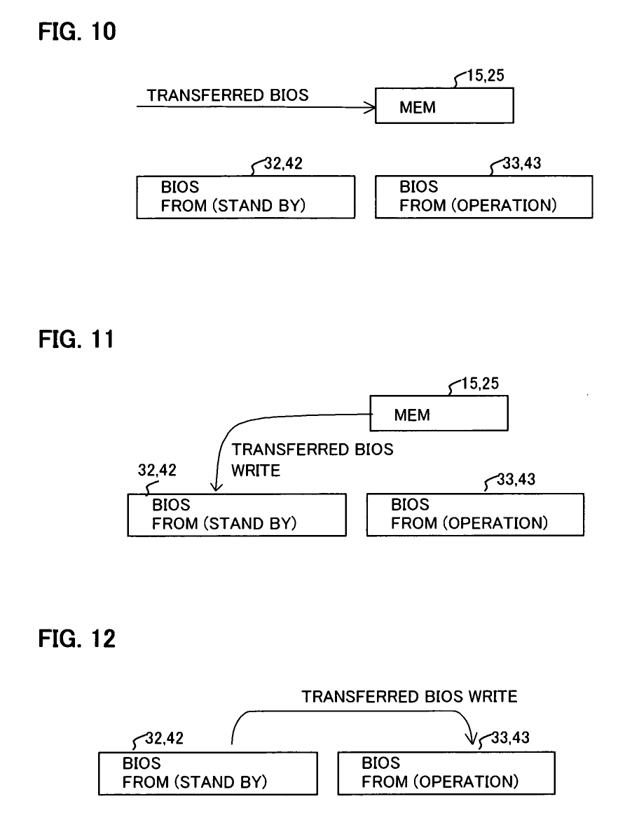

At first, the update of BIOS will be described with reference to FIG. 5, FIG. 6, FIG. 7, and FIG. 10 to FIG. 12. As FIG. 5 shows, the flash write to the BIOS flash memory (Flash ROM) 33 is performed from firmware using the user interface.

In other words, the personal computer (hereafter called PC) 6 is connected to the LAN port 36 of the controller 1 via the hub 7, and a flash write to the BIOS flash memory is executed by the processing in FIG. 6 and FIG. 7. FIG. 6 is a flow chart depicting update instruction processing of BIOS.

(S20) BIOS update is instructed from the CGI screen of the PC 6. In other words, the BIOS update screen is displayed, where the update is instructed.

(S21) The maintenance task 110, which the CPU 10 of the controller 1 executes, acquires the BIOS version number from the configuration, and notifies this to the CGI of the PC 6.

(S22) CGI of the PC 6 displays the notified BIOS version number, which is currently operating, on the CGI screen. After the user confirms this, the CGI of the PC 6 transfers the BIOS ROM image to the maintenance task 110, which the CPU 10 executes.

(S23) The maintenance task 110 checks the checksum of the BIOS ROM image received from the CGI and notifies an abnormality to the CGI if one exists. If no abnormality exists, the maintenance task 110 notifies the transferred BIOS version number to the CGI.

(S24) CGI displays the checksum error on the CGI screen if a checksum error occurred.

(S25) If normal, CGI displays the BIOS version number received from the maintenance task on the screen for final confirmation on whether or not this BIOS is updated.

(S26) If processing is continued, the CGI sends a flash write instruction to the maintenance task 110. The maintenance task 110 receives the flash write instruction and executes the BIOS flash write processing in FIG. 7.

FIG. 7 is a flow chart depicting the flash write processing which the maintenance task executes.

(S30) When the BIOS flash write instruction is received, the maintenance task 110 acquires the flash memory number (32 or 33 in FIG. 1) of the currently operating BIOS from the current SW 122 of the NVRAM (see FIG. 3) in the RSP 34/44.

(S32) Then the maintenance task 110 invalidates the version number of the standby BIOS version number 126 of the NVRAM (see FIG. 3) in the RSP 34/44. By this, automatic switching of the BIOS flash ROM is prevented.

(S34) The BIOS flash memory in standby is determined from the flash memory number of the currently operating BIOS in step S30, and using the function provided by the kernel 102, the transferred BIOS is flash-written to the flash ROM of the BIOS which is not currently operating (standby side). At this time, the BIOS Boot Block is also flash-written.

(S36) The maintenance task 110 judges whether the flash write ended normally.

(S38) When it is judged that flash write ended normally, the maintenance task 110 sets the flash-written BIOS flash ROM number to the BIOS number to be started up at the next startup of the BIOS SW 124 of NVRAM (see FIG. 3) in the RSP 34/44. The maintenance task 110 also sets the flash-written BIOS version number to the standby BIOS version number 126 of the NVRAM (see FIG. 3) in the RSP 34/44, and this updated flash ROM is validated. Therefore at the next startup, the updated BIOS is selected. Also the maintenance task 110 notifies the Web that the update of BIOS ended normally to confirm this with the CGI of the PC 6 by the user. And processing ends.

(S40) When it is detected that a flash write error occurred during the BIOS update in step S36, on the other hand, the maintenance task 110 notifies the system control 104 that the standby side BIOS flash memory is abnormal, and sets the status of the erred controller to be a status which requires preventive maintenance (for example the status lamp is set to orange). And failure of the BIOS update is displayed on the CGI screen of the PC 6. In this case, the BIOS SW 124 and the standby BIOS version number 126 are not updated, so automatic switching to the erred BIOS flash ROM can be prevented.

In this way, when BIOS is updated, two BIOS flash ROMs are not flash-written simultaneously, but only the BIOS flash ROM at the standby side is flash-written. This is because it is not safe to update the currently operating BIOS. In other words, even if the flash write fails, the system can be started up by the currently operating BIOS since the currently operating BIOS is not updated, so the system startup can be prevented from being disabled.

Also if a power failure occurs during a flash write, power recovery processing must be performed by a BIOS which is different from the BIOS before the power failure if the currently operating BIOS is updated, and a Fast Boot must be guaranteed between BIOSs with different version numbers, so only the BIOS flash ROM at the standby side is flash-written. Fast Boot is a mode where the controller is started up without memory initialization to guarantee the data on the cache at power recovery, since the backup battery causes to hold data in the cache area of the memory 15/25 in the controller when a power failure occurs. If the BIOS version number differs between a power failure and a power recovery, the hardware initialization procedure changes, and memory data cannot be guaranteed.

In the case of the model in FIG. 1 where two controllers 1 and 2 are connected, commands and information which the controller 1 received from the PC 6 are transferred to the controller 2 via the PNB 30/40 just like the maintenance task 110 of the controller 1 in FIG. 1, and the maintenance task 110 in the controller 2 performs the identical operation. Therefore the BIOS flash ROM at the standby side of the controller 2 is simultaneously updated.

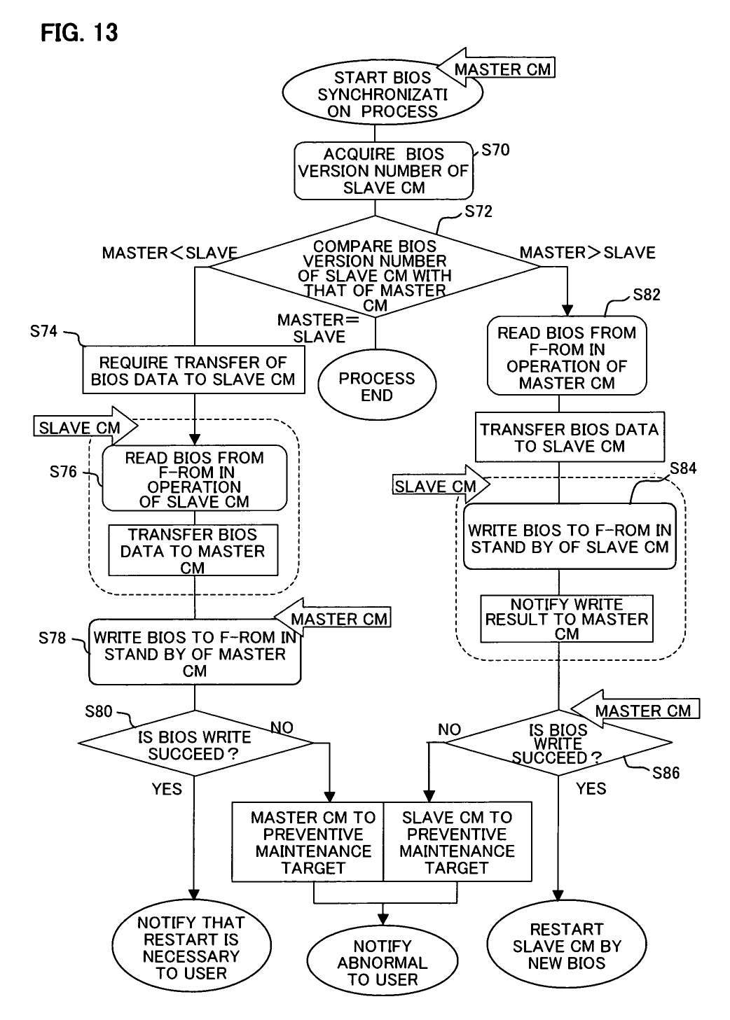

In this case, if only one controller fails the update of the BIOS when BIOS is updated, failure of the BIOS update is notified on the CGI screen of the PC 6. When the controller for which the update failed is started up next time, the BIOS to be started up is not switched, and the system is started up with the current BIOS. In this status, the BIOSs of the two controllers have not been processed for redundancy, but are processed for redundancy, as described later in FIG. 13, when power is turned ON the next time.

Now the switching processing of the BIOS when the controller is started up will be described. FIG. 8 is a flow chart depicting the BIOS startup processing of RSP when the controller is started up.

(S50) When the controller is restarted at an appropriate timing, the RSP 34/44 acquires the Boot mode (Fast/Slow) from the boot mode 120 of the NVRAM (see FIG. 3) in the RSP 34/44. The Fast boot mode is a mode in which the previously started BIOS is started at the power recovery after power failure. The Slow boot mode is a mode in which the system is started with the updated BIOS at normal power ON.

(S52) The RSPs 34 and 44 judge the boot mode, and if Fast, processing moves to step S56. In other words, step S54 is skipped and data is matched when power is recovered using the BIOS before power failure occurred.

(S54) If it is judged as Slow, on the other hand, the BIOS number to be started at the next startup of the BIOS SW 124 of the NVRAM (see FIG. 3) in the RSP 34/44 is acquired, and the acquired BIOS number is set in the current SW 122 of the NVRAM (see FIG. 3) in the RSP 34/44. Therefore the startup BIOS is switched to the updated BIOS.

(S56) The RSP 34/44 starts up the BIOS which is set in the current SW 122 of the NVRAM (see FIG. 3).

In this way, except in the case of power recovery, the BIOS is switched to the updated BIOS at startup. In the case of power recovery, a conventional BIOS is started up.

FIG. 9 is a flow chart depicting the BIOS redundancy processing which the power control executes.

(S60) When BIOS processing (FIG. 4) ends, in the BIOS redundancy processing in the power control 106, the BIOS number to be started at the next startup of the BIOS SW 124 of the NVRAM (see FIG. 3) in the RSP 34/44 and the currently operating BIOS number of the current SW 122 are acquired.

(S62) It is judged whether the BIOS number to be started at the next startup of the BIOS SW 124 and the currently operating BIOS number of the current SW 122 match If there is no match, the current operation is not started up with the BIOS specified for the next startup, such as the case of power recovery after power failure, so redundancy processing is not performed, and processing ends.

(S64) If the BIOS numbers match, it is checked whether the standby BIOS version number 126 of the RSP 34/44 is invalid. If the standby BIOS version number is invalid, the standby BIOS is abnormal, so processing moves to redundancy processing in step S68.

(S66) If the standby BIOS is not invalid, the version number of the BIOS in operation and the version number of the BIOS in standby are compared and judged whether they match. If there is a match, the version numbers of both BIOSs are the same, so redundancy processing is unnecessary, and processing ends.

(S68) If there is no match, redundancy processing is necessary, so the BIOS image in operation is flash-written to the BIOS flash memory at the standby side. For the BIOS ROM image which is written at this time, the data of the currently operating BIOS flash ROM is used. And the standby BIOS version number of NVRAM of the RSP 34/44 is set, the standby side is validated, and redundancy processing ends.

FIG. 10 to FIG. 12 are diagrams depicting the operation thereof. As FIG. 10 shows, the transferred BIOS is written to the memory 15/25 by the processing in FIG. 6. When a flash write is permitted in FIG. 6, the transferred BIOS in the memory 15/25 is written to the BIOS flash ROM 32/42 at the standby side in the processing in FIG. 7. And as FIG. 12 shows, the standby side is started up by the processing in FIG. 8 when the controller is started up, and the currently operating BIOS flash-ROM 33/43 becomes the standby side. By the processing in FIG. 9, the BIOS of the BIOS flash ROM 32/42, which was changed during operation, is written to the BIOS flash ROM 33/43, which was changed during standby.

When a flash write error occurs during the BIOS redundancy processing in step S68, the operation of the controller has no problem so the controller is started up by ready, but the controller where the error occured becomes the status where preventive maintenance is required (status lamp is orange). Also the standby side is not invalidated, so automatic switching to the BIOS flash ROM where the error occurred is disabled.

Also when BIOS does not start up normally in the restart after the BIOS update (when the new BIOS does not startup normally), the BIOS flash ROM is not automatically switched, instead it is switched to an older version BIOS using the front panel. The user can identify that the new BIOS did not startup normally when the BIOS does not startup at restart.

Also when one flash ROM of the two BIOS flash ROMS becomes abnormal in normal operation, BIOS can be started up using the other flash ROM. For this switching, the BIOS flash ROM is switched by an instruction from the user interface.

For automatic switching, RSP 34/44 detects a Heart Beat Error (no response from BIOS) during Boot block processing of BIOS, and switches the BIOS flash ROM. The BIOS flash ROM is switched only when the BIOS at the standby side can be used (valid), and if it cannot be used, the BIOS flash ROM is not switched but is degraded. If BIOS processing ends after switching and firmware can be started up, the BIOS redundancy processing described in FIG. 9 is executed.

[BIOS Synchronization Processing Between CMs]

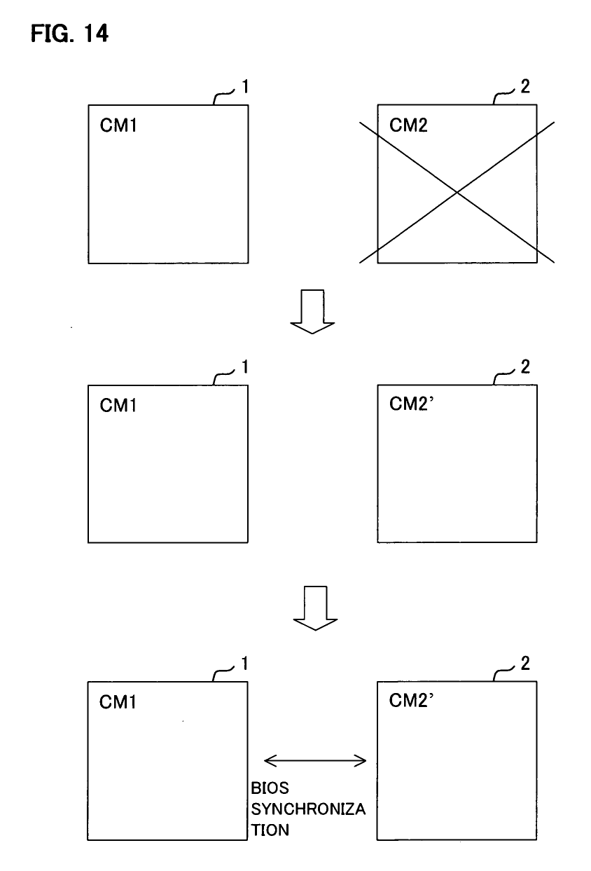

Now the BIOS synchronization processing between CMs (Centralized Modules) shown in FIG. 1 when two controllers are mounted, also shown in FIG. 1, will be described. For example, when the CM 2 of the controller 2 fails and is replaced with the CM 2′ as shown in FIG. 14, BIOSs are synchronized between the CM 1 of the controller 1 and the CM 2′ of the controller 2, so that the BIOS version numbers become the same when the CM is replaced.

When the BIOS of the Slave CM (e.g. CM of the controller 2) is updated, the system is automatically restarted with the new BIOS. When the BIOS of the master CM (e.g. CM of the controller 1) is updated, an automatic Reboot is not executed, and this information is notified to the user.

FIG. 13 is a flow chart depicting the BIOS synchronization processing between the CMs.

(S70) The master CM starts the BIOS synchronization processing. At first, the BIOS version number of the slave CM is acquired.

(S72) The master CM compares the BIOS version number of the master CM and the BIOS version number of the slave CM. If they match, BIOS synchronization is unnecessary, and processing ends.

(S74) In the comparison, if the BIOS version number of the master CM is smaller than the BIOS version number of the slave CM, that is if the BIOS of the master CM is older, the BIOS of the master CM must be updated. At first, the master CM requests the slave CM to transfer the BIOS data.

(S76) The slave CM reads the BIOS from the BIOS flash ROM operating in the slave CM, and transfers it to the master CM.

(S78) The master CM writes the transferred BIOS to the BIOS flash ROM at the standby side. By this, the BIOS with the old version number is updated.

(S80) The master CM judges whether the writing of the BIOS succeeded, and if it succeeded, the user is notified that the BIOS was updated and that a restart is necessary. And by the restart, update of the BIOS completes. If the writing of the BIOS fails, conversely, the BIOS flash ROM at the standby side of the master CM is abnormal, so the master CM becomes a preventive maintenance target, and the abnormality is notified to the user.

(S82) If the BIOS version number of the master CM is greater than the BIOS version number of the slave CM in the comparison in step S72, that is if the BIOS of the master CM is new, the BIOS of the slave CM must be updated. At first, the master CM reads the BIOS from the BIOS flash ROM operating in the master CM, and transfers it to the slave CM.

(S84) The slave CM writes the transferred BIOS to the BIOS flash ROM at the standby side. By this, the BIOS with the old version number is updated. And the slave CM notifies the write result to the master CM.

(S86) The master CM judges whether the writing of the BIOS succeeded from the notification result, and if it succeeded, the slave CM is restarted and the update of the BIOS completes. If the writing of the BIOS fails, conversely, the BIOS flash ROM at the standby side of the slave CM is abnormal, so the slave CM is set as a preventive maintenance target, and the abnormality is notified to the user.

In this way, the CMs are synchronized to be a new BIOS.

### OTHER EMBODIMENTS

In the above mentioned embodiments, a RAID having the redundancy configuration shown in FIG. 1 was described, but the present invention can be applied to storage systems having other redundancy configurations. For a physical disk, a magnetic disk, optical disk, magneto-optical disk and various other types of storage devices can be used.

Application to a storage system was described above, but the present invention is not limited to storage, but can be applied to other controllers and data processing apparatus. Also the example of using two CMs was described, but the present invention can be applied to one CM, and a flash memory was used for storing the BIOS, but other non-volatile rewritable memories can be used.

The present invention was described using embodiments, but the present invention can be modified in various ways within the scope of the essential character of the present invention, and these shall not be excluded from the scope of the present invention.

As described above, in the present invention, the BIOS is, redundancy-managed by a pair of memories, so that the system startup is prevented from being disabled by switching to the memory in standby when the BIOS cannot be booted. Also when the BIOS is updated according to the CPU stepping change, BIOS data is not written to the two BIOS memories simultaneously, but is written to only the BIOS memory at the standby side, and the currently operating BIOS is not rewritten, so even if the update fails, the system can be started up using the currently operating BIOS, which can prevent the system startup from being disabled.

Since only the memory at the standby side is updated, even if a power failure occurs during writing the memory for update, performing power recovery processing with a BIOS different from the one being used before the power failure can be prevented.

What is claimed is:

1. A redundancy management method for BIOS, comprising the steps of:
using one of a pair of memories, which respectively store the BIOS for setting hardware in an environment in which OS can use said hardware, for operation and the other for standby;
switching to the BIOS in said memory in standby when the BIOS in said one memory cannot be booted; and
executing an update of said BIOS by writing to said memory in standby.

2. The redundancy management method for BIOS according to claim 1, further comprising a step of permitting switching said memory in standby to in operation when the update of said BIOS in said memory in standby succeeded.

3. The redundancy management method according to claim 2, further comprising a step of switching said permitted memory in standby to in operation, and said memory in operation to in standby when said hardware is started up.

4. The redundancy management method for BIOS according to claim 3, further comprising a step of writing the BIOS of said memory switched to operation, to said memory switched to standby for redundancy after said switching.

5. The redundancy management method for BIOS according to claim 1, further comprising a step of preventing switching of said memory in standby to said memory in operation when the update of said BIOS in said memory in standby failed.

6. The redundancy management method for BIOS according to claim 4, further comprising a step of preventing switching said memory switched to standby, to said memory in operation when writing of said BIOS in said memory switched to standby failed.

7. The redundancy management method for BIOS according to claim 3, further comprising a step of preventing execution of said switching when said hardware is started up for power recovery.

8. The redundancy management method for BIOS according to claim 4, further comprising a step of preventing execution of said redundancy step when said hardware is started up for power recovery.

9. The redundancy management method for BIOS according to claim 1, further comprising a step of executing the update of BIOS in a memory in standby of another hardware connected with said hardware according to the update of the BIOS in said memory in standby of said hardware.

10. The redundancy management method for BIOS according to claim 1, further comprising a step of executing the synchronization processing of the BIOS with another hardware connected with said hardware.

11. A data processing apparatus, comprising:
a hardware including a CPU;
a pair of memories which respectively store a BIOS for setting said hardware in an environment in which OS can use said hardware; and
a service processor for using one of said pair of memories for operation and the other for standby when said hardware is started up and switching to the BIOS in said memory in standby when the BIOS of said one memory cannot be booted,
wherein said CPU executes the update of said BIOS by writing to said memory in standby.

12. The data processing apparatus according to claim 11, wherein said service processor permits switching said memory in standby to said memory in operation when the update of said BIOS in said memory in standby succeeded.

13. The data processing apparatus according to claim 12, wherein said service processor switches said permitted memory in standby to a memory in operation, and said memory in operation to said memory in standby when said hardware is started up.

14. The data processing apparatus according to claim 13, wherein said CPU writes the BIOS of said memory switched to operation, to said memory switched to standby for redundancy after said switching.

15. The data processing apparatus according to claim 11, wherein said CPU prevents switching said memory in standby to the memory in operation when the update of said BIOS in said memory in standby failed.

16. The data processing apparatus according to claim 14, wherein said CPU prevents switching said memory switched to standby, to said memory in operation when writing of said BIOS in said memory switched to standby failed.

17. The data processing apparatus according to claim 11, further comprising another hardware connected with said hardware, and
said hardware executes the update of the BIOS in the memory in standby of said other hardware connected with said hardware according to the update of the BIOS in said memory in standby of said hardware.

18. The data processing apparatus according to claim 11, wherein said hardware executes the synchronization processing of the BIOS with said other hardware connected with said hardware.

19. A storage system, comprising:
a storage control apparatus comprises:
a hardware including a CPU;
a pair of memories which respectively store a BIOS for setting said hardware in an environment in which OS can use said hardware; and
a service processor for using one of said pair of memories for operation and the other for standby when said hardware is started up and switching to the BIOS in said memory in standby when the BIOS of said one memory cannot be booted; and
a plurality of storage devices connected to said storage control device,
wherein said CPU of said storage control apparatus executes the update of said BIOS by writing to said memory in standby.

20. The storage system according to claim 19, wherein said service processor of said storage control apparatus permits the switching of said memory in standby to said memory in operation when the update of said BIOS in said memory in standby succeeded.

21. The storage system according to claim 20, wherein said service processor of said storage control apparatus switches said permitted memory in standby to a memory in operation, and said memory in operation to said memory in standby when said hardware is started up.

22. The storage system according to claim 21, wherein said CPU of said storage control apparatus writes the BIOS of said memory switched to operation, to said memory switched to standby for redundancy after said switching.

23. The storage system according to claim 19, wherein said CPU of said storage control apparatus prevents switching said memory in standby to the memory in operation when the update of said BIOS in said memory in standby failed.

24. The storage system according to claim 22, wherein said CPU of said storage control apparatus prevents switching said memory switched to standby, to said memory in operation, when writing of said BIOS in said memory switched to standby failed.

25. The storage system according to claim 19, further comprising another storage control apparatus, which is connected to said storage devices and said storage control apparatus and for controlling said storage devices,
wherein said storage control apparatus executes the update of the BIOS in the memory in standby of said other storage control apparatus according to the update of the BIOS in said memory in standby of said storage control apparatus.

26. The storage system according to claim 19, further comprising another storage control apparatus, which is connected to said storage devices and said storage control apparatus and for controlling said storage devices,
wherein said storage control apparatus executes the synchronization processing of the BIOS with said other storage control apparatus.
